(19) United States
(12) Patent Application Publication
(10) Pub. No.: US 2005/0010415 A1
(43) Pub. Date: Jan. 13, 2005

(54) Artificial intelligence dialogue processor

(76) Inventors: David A. Hagen, Southern Pines, NC (US); Rick Stefanik, Pinehurst, NC (US)

Correspondence Address: SMITH MOORE LLP, P.O. BOX 21927, GREENSBORO, NC, 27420, US

(21) Appl. No.: 10/852,300

(22) Filed: May 24, 2004

Related U.S. Application Data
(60) Provisional application No. 60/473,104, filed on May 24, 2003.

(51) Int. Cl. G10L 11/00

(52) U.S. Cl. 704/270

(57) ABSTRACT

An artificial intelligence dialogue processor is an integrated software solution that mimics human behavior including a dialogue oriented knowledge database that contains static and dynamic data relating to human scenarios. The knowledge base is composed in a proprietary XML-based universal format and the processor further includes translation, processing, and analysis components that facilitate composition of the core knowledge base and are responsible for processing vocal and/or textual and/or video input, extracting emotional characteristics of the input, and producing instructions on how to respond to the customer with the appropriate substantive response and emotion based on relevant information found in the knowledge base.

This application claims the benefit of U.S. Provisional Application No. 60/473,104, filed on May 24, 2003.

### BACKGROUND OF THE INVENTION

The present invention relates to artificial intelligence, and more particularly, to a human-like information management and delivery system.

Gatelinx, Corp., assignee of the present invention, has proposed several systems, methods, and apparatuses for improving sales to potential consumers through a number of portals, such as stationary kiosks, set top boxes, portable kiosks, desktop computers, laptops, handheld computers, and personal digital assistants. In many of these systems, the portal customer is greeted by a live image of a remote salesperson or a visual image of a fictitious salesperson whose voice is supplied by a live person. The remote salesperson may introduce the product to the customer, provide the customer with on screen documentation, share files with the customer at the portal, and answer the customer's questions, for example. While these sales techniques are innovative and unique, they both require that a live salesperson be available to talk to the customer in a conversational manner. In today's economic market, companies are seeking ways to streamline their work force operations. However, studies have shown that it is advantageous to have a live salesperson introduce a product and close the sale.

Accordingly, there is a need in the art for an information management and delivery system that is able to mimic the characteristics of a human, and in particular, a human salesperson.

### BRIEF SUMMARY OF THE PRESENT INVENTION

An artificial intelligence dialogue processor that is an integrated software solution that mimics human behavior including a dialogue oriented knowledge database that contains static and dynamic data relating to human scenarios. The knowledge base is composed in a proprietary XML-based universal format. The processor further includes translation, processing and analysis components that facilitate composition of the core knowledge database, process vocal and/or textual and/or video input, extract emotional characteristics of the input, and produce instructions on how to respond to the customer with the appropriate substantive response and emotion based on relevant information found in the knowledge base.

### DETAILED DESCRIPTION OF THE PREFERRED EMBODIMENTS

The present invention provides an information management and delivery system that mimics the characteristics of human behavior. Crucially, the system is heavily “dialogue-oriented”, an important distinction from other natural language based systems which generally have a simple “in-out” process flow. The system is particularly useful when a company uses web sites, kiosks and other remote portals to enable a fictitious sales agent talk to an interested customer. An example of this type of use is discussed herein for the purpose of merely describing the present invention. It should be understood that the present invention is not limited to this type of use.

When a customer approaches a kiosk and requests to initiate a conference with a remote agent, the customer expects to be greeted with a typical introduction such as “Good morning” or “Hello, how are you doing today?” The present invention, in its most basic form and function, comprises a knowledge database that is stored on a server and includes a multitude of predetermined greetings, with rules regarding when to use a particular one of the greetings. The customer may respond to any such greeting in any number of different ways. For example, the customer may reply by stating in a happy voice “I am doing well, thank you!” or the customer may respond in a saddened voice “My day is not going so well.” On the most basic level of social interaction, the system is ready to respond to many typical behaviors that may be encountered, and to carry the interaction forward, all on the basis of the data stored in its knowledge database.

The knowledge database has a flexible, universal format that stores knowledge and dialogue behaviors from the simplest greeting/response to much more complicated scenarios. The present invention thus further comprises a flexible, extensible translation and analysis component, which converts complicated scenarios into the universal format, so that the system recognizes and processes vocal and/or textual and/or video input provided by the customer, extracts emotional characteristics of the input and instructs the fictitious agent on how to respond to the customer with the appropriate substantive response and emotion. In particular, the translation and analysis process constructs the system's functionality by using terms that are “native” to particular scenarios. For instance, a sales process can be constructed using terms like “pre-qualification”, “close”, and the like. The parts of a process that must never change are built into concept blocks employed in the use case, whereas the parts that may change are carefully parameterized to allow easy modification without deviating from the boundaries of what is sensible for the use case. So, for example, a sales process use case can allow changing the aggressiveness of a close, but can never allow the close to be placed out of order in the overall sales process.

The data stored in the knowledge database can be manipulated dynamically, as would be expected from a database system, but also certain data can be marked as unchangeable. The definition of what is static and what is dynamic generally originates at a higher level, but has direct correspondences, via the translation process, to lower-level constructs. The fact that all of the system's knowledge and behavior is stored in the same format, including those parts which never change, avoids a classic trap of other artificial intelligence systems in which certain meta-rules are hard-coded into the system using a different language from the rest of the system; for example, if a system encodes grammatical rules in a programming language like C++, this may introduce a rigidity when certain scenarios (coded in the knowledge format) call for exceptions to those rules.

The translation/analysis mechanism permits “high-level” constructs to be manipulated without concern for the actual workings of the engine comprising the translator. The engine itself is like a programming language interpreter, providing most of the features of a traditional programming language, but optimized for the specific needs of a language-intensive application like those mentioned above. “Real world” concepts often cannot be easily expressed in these “low level” concepts, so the system includes a flexible series of translation layers that manage the “conceptual transition” from the real world to the universal knowledge base format. Maintaining these distinct layers above the engine allows for optimization and simulation of additional functionality of the engine or effectively adjusting the architecture and functionality of the engine without disturbing the models of real-world scenarios in which the system must operate. The decoupling between the translation layers and the engine also makes it possible to adjust and/or build new translation layers without the necessity to modify the engine.

The information management and delivery system of the present invention is so robust because it achieves a new level of needed separation among conceptual levels of an artificial intelligence system. It places critical restrictions on the higher-level modeling, restrictions which avoid conventional problems of object modeling in artificial intelligence systems while still providing the necessary types of strength required for modular design of an unlimited set of scenarios.

The XML-based modeling toolkit of the present invention relies on “intuitive” embedding/containment and recursion. A recursive process is a process that is partly defined in terms of itself. Recursive structures are well-known in human language, in which, for example, a verb phrase may itself consist of other verb phrases. The “intuitive” aspect of the invention is the ability to rely upon such recursion, or upon the possibility of embedding one structure in any “sensible” place within another. This intuitive capability is provided by the translation process in such a fashion that the user of the high-level modeling system finds that all combinations and assortments of modules produce expectable behavior, just as a compact expression in human language such as “keep going” belies in its simplicity the complex of recursive evaluations and decisions that are made when applying such an instruction “naturalistically” to a human scenario.

The approach can also be related to a programming language that is “loosely typed”. The high-level modeling does not require unnecessary “typing” (assignment of types) of concepts, such that the modeler is not required to think in strictly “grammatical” terms (for example) if those do not apply in a given scenario. Pseudo-grammatical and pseudo-logical structures and strategies may be employed without penalty, and without compromising the correct (desired) functionality in other scenarios that require stricter or more conventional approaches. Hence, the translation of each module can be handled as a process that is largely independent of other modules.

A significant part of the code generated by the higher-level modules relies upon pattern matching; however, at the textual level, very specific, exact, atomic matches (e.g., “cat” matches “cat”) are generally used (rather than complicated patterns). The effective matches become more and more inexact towards the higher, more conceptual levels of the use cases (e.g., “I don't have a TV” matches “I don't have a credit card” in relevant contexts). If these match trees were directly constructed, either manually or by using conventional semantic analysis approaches, the result would be an unmanageable complex of regular expressions. The translation process essentially mediates this process by surrounding the expressions with a lot of context. This context is what is used to replace what would otherwise be wild strands of back references and self-modifying variables in these giant regular expressions. Instead of trying to express the computation of a result as a process involving the iterative modification of several different variables, the conceptual layering approach is used to eliminate, as much as possible, the need for variables at all.

The approach used by the present invention is unique in that it combines regular expressions with a strict methodology that requires each individual module to be expressed in terms that are limited to a singular functional scope regardless of the level of abstraction. It is important to the strength of the system that, at the lowest level, the full power of regular expressions (a deeply developed aspect of computer science) is available, while at the same time, the meaning of “pattern matching” at various conceptual levels of the system is highly malleable, context-specific, and not bound to any particular language. Rather than extend a given pattern language indefinitely, overloading one system with too many concepts, this system permits multiple subsystems to “multiply” against each other; for instance, the full power of regular expressions against a more simple adhoc “matching” concept that is highly specific to one dialogue context. In other words, the system does not use a typical “semantic” approach, because it does not force all concepts to be expressed in some single metalanguage. The system is also not an open-ended object-oriented language, because it does impose strong design requirements on each individual piece.

The one aspect in which the system extends the power of regular expressions in a new way is through an “adjustability” feature that permits the optimized order of regular expression matching to be defined using regular expressions themselves. In other words, the system of regular expressions is multiplied by itself. The result essentially handles the “collection usage” dimension of pattern matching, which is not addressed by regular expressions alone.

The system further comprises an elegant model of context that is highly agnostic as to any situational connotation of “context”. In other words, it permits context to be “understood” and used in different senses that are appropriate and specific to given dialogue scenarios. Once the high level structures have been translated into the universal format, the context mechanism is used to select a path through the database of knowledge and behaviors. The rules for selecting the path are simple and “intuitive”, and the translation process is optimized to produce structures that make maximal use of those rules. The high level models themselves are unburdened of the responsibility to dictate the minutiae of transition from each step to the next-a critical advantage, since even the simplest interactions may comprise hundreds of small steps at the lowest level.

Unlike prior art artificial intelligence systems that are based on pattern-matching, the present invention is less likely to become brittle or old because its initial knowledge store is built up in the same fashion as new knowledge is acquired or learned, according to the principles outlined above. Further, the present invention avoids the pitfalls of prior art systems that are too complex to trace because of an inappropriate intermixture of application-level concerns (“use cases”) with implementation details (the particulars of the interpreter or “low-level” language).

Certain modifications and improvements will occur to those skilled in the art upon a reading of the foregoing description. By way of example, the present invention is not limited to a remote sales pitch. Rather, the system may be utilized in a multitude of applications such as remote therapy, education, and customer service. All such modifications and improvements of the present invention have been deleted herein for the sake of conciseness and readability but are properly within the scope of the present invention.

1. An artificial intelligence dialogue processor that mimics human behavior comprising:
a dialogue oriented knowledge database comprising static and dynamic data relating to human scenarios, the database being stored on a server in a universal XML-based format;
translation and analysis components that facilitate composition of the knowledge database by utilizing multiple data sources and unifying data presented in different formats into the universal XML-based format;
wherein the processing and analysis components process input selected from the group consisting of vocal, textual, and video input, extract emotional characteristics of the input, and produce instructions on how to respond to the customer with the appropriate substantive response and emotion based on relevant information found in the knowledge database.

2. The artificial intelligence dialogue processor of claim 1 further comprising predetermined word expressions and rules for when to use said word expressions.

3. The artificial intelligence dialogue processor of claim 1 further comprising an XML based modeling toolkit that relies on intuitive embedding, containment, and recursion of data.

4. The artificial intelligence dialogue processor of claim 1 wherein the processor relies upon pattern matching and atomic matching of word expressions.

5. The artificial intelligence dialogue processor of claim 4 wherein the processor surrounds word expressions with context regarding particular human scenarios.

6. The artificial intelligence dialogue processor of claim 1 further comprising an adjustable feature that permits the order of word expressions to be defined using the word expressions themselves.
